(19) United States
(12) Patent Application Publication
(10) Pub. No.: US 2016/0081867 A1
(43) Pub. Date: Mar. 24, 2016

(54) MODULAR THERAPY MATTRESS

(71) Applicant: Andrew Laurence O'Sullivan, Greenlane (NZ)

(72) Inventor: Andrew Laurence O'Sullivan, Greenlane (NZ)

(21) Appl. No.: 14/861,373

(22) Filed: Sep. 22, 2015

(30) Foreign Application Priority Data
Sep. 23, 2014 (NZ) 700331

(51) Int. Cl. A61G 7/057; A47C 27/18; A47C 27/14; A47C 27/08; A47C 27/15

(52) U.S. Cl. CPC A61G 7/05715; A47C 27/088; A47C 27/085; A47C 27/15; A47C 27/148; A47C 27/18; A61G 7/05738; A61G 7/05776

(57) ABSTRACT

A modular therapy mattress is disclosed. The mattress comprises a base of high density foam, an upper panel of high density foam attached to the base in an upper body and head region of the mattress, the upper panel having a lower firmness than the base, and one or more inserts fitted to the base in a trunk, lower leg or heel region of the mattress. The inserts comprise one or more of (i) a gel infused visco-elastic memory foam panel bonded to a foam panel base, the foam panel base having a higher firmness than the gel infused visco-elastic memory foam panel, (ii) a visco-elastic memory foam panel bonded to a foam panel base, the foam panel base having a higher firmness than the visco-elastic memory foam panel, and (iii) an air cell panel comprising a plurality of air cells formed from a generally flat base sheet and a top sheet both made from an air impervious material, the top sheet molded to form the plurality of air cells fixed to the base sheet around bottom edges of the air cells. A cover fully envelopes the base, the upper panel and the insert or inserts fitted to the base.

### FIELD OF THE INVENTION

The present invention relates to a mattress, and specifically a modular therapy mattress particularly suitable for use by a bed-bound patient.

### BACKGROUND TO THE INVENTION

Bed bound patients, such as patients who have suffered a stroke, or other patients who require bed rest, typically prefer a raised or elevated head position in bed. For example, in a hospital or in-home health care or other health care environment beds are often adapted to have at least a head end of the bed moveable between a lowered or horizontal position and a raised or elevated position. Patients typically prefer a raised head position allowing the patient to sit in a seated position in bed or lie in bed in an elevated position with the upper body raised.

A bed bound patient can develop pressure ulcers over time caused by contact pressure of the mattress against the patient's body due to the weight of the patient on the mattress. Furthermore, a seated or elevated lying position for extended periods of time can further increase mattress pressure and/or shear forces on the patient, increasing the chances of pressure ulcers. Pressure ulcers can begin to occur in as little time as 20 minutes on high risk patients and longer on more mobile patients. More information regarding pressure ulcers is published by the European Pressure Ulcer Advisory Panel (EPUAP).

It is an object of the present invention to provide an improved mattress to improve comfort and reduce the occurrence of pressure ulcers on a bed bound patient, or to at least provide the public or health services with a useful choice.

### SUMMARY OF THE INVENTION

In one aspect, the present invention consists in a modular therapy mattress comprising:

a base of high density foam,

an upper panel of high density foam attached to the base in an upper body and head region of the mattress, the upper panel having a lower firmness than the base,

one or more inserts fitted to the base in a trunk, lower leg or heel region of the mattress, wherein the inserts comprise one or more of:
(i) a gel infused visco-elastic memory foam panel bonded to a foam panel base, the foam panel base having a higher firmness than the gel infused visco-elastic memory foam panel,
(ii) a visco-elastic memory foam panel bonded to a foam panel base, the foam panel base having a higher firmness than the visco-elastic memory foam panel,
(iii) an air cell panel comprising a plurality of air cells formed from a generally flat base sheet and a top sheet both made from an air impervious material, the top sheet molded to form the plurality of air cells fixed to the base sheet around bottom edges of the air cells, and

a cover fully enveloping the base, the upper panel and the insert or inserts fitted to the base.

In some embodiments the width of the air cell panel is less than the width of the base and the upper panel, in use the air cell panel mounted centrally between longitudinal edges of the base. In some embodiments the width of the air cell mattress is 20 mm to 200 mm, or 20 mm to 150 mm, or 20 mm to 100 mm, or 50 mm to 100 mm or about 80 mm less than the width of the base.

In some embodiments the width of the upper panel, the gel infused visco-elastic memory foam panel, and the visco-elastic memory foam panel is approximately the same as the width of the base.

In some embodiments the thickness of the base is less than the thickness of the inserts. In some embodiments the thickness of the inserts is approximately 1 to 2 times the thickness of the base. In some embodiments the thickness of the inserts is approximately 1.5 times the thickness of the base.

In some embodiments the thickness of the gel infused visco-elastic memory foam panel is similar to the thickness of the foam panel base to which it is bonded.

In some embodiments the thickness of the visco-elastic memory foam panel is similar to the thickness of the foam panel base to which it is bonded.

In some embodiments in use the gel infused visco-elastic memory foam panel is fitted to the base in the trunk region of the mattress.

In some embodiments in use the visco-elastic memory foam panel is fitted to the base in the lower leg or heel region of the mattress.

In some embodiments in use a said visco-elastic memory foam panel is fitted to the base in the lower leg or heel region of the mattress, and a said visco-elastic memory foam panel is fitted to the base in the trunk region of the mattress, and wherein the density of the visco-elastic memory foam in the truck region of the mattress is greater than the density of the visco-elastic memory foam in the lower leg or heel region of the mattress.

In some embodiments in use the air cell panel is fitted to the lower leg or heel region.

In some embodiments the modular therapy mattress comprises one or more said air cell panels, in use the air cell panels fitted to the trunk region and the lower leg or heel region.

In some embodiments the base thickness is about 50 mm or 2 inches and the insert thickness is about 75 mm or 3 inches, the overall thickness of the mattress being about 125 mm or 5 inches.

In some embodiments the upper body and head region is approximately 25% of the length of the mattress, the lower leg or heel region is approximately 25% of the length of the mattress, and the trunk region located in between the upper body and head region and the lower lea or heel region is approximately 50% of the length of the mattress.

In some embodiments the insert fitted to the base in the trunk region is approximately twice the length of the insert fitted to the base in the lower leg or heel region.

In some embodiments the modular mattress comprises three said inserts, the inserts having approximately the same length, two inserts of the same construction fitted to the base in the trunk region and one insert fitted to the base in the lower leg or heel region.

In some embodiments the modular therapy mattress comprises three said inserts fitted to the base in the lower leg or heel region and the trunk region, each insert comprising an air-cell panel. In some embodiments the three inserts are of the same length.

In some embodiments, with the insert or inserts fitted to the base, the overall thickness of the mattress in the upper body and head region, the trunk region and the lower leg or heel region is substantially the same.

In some embodiments the cover is impervious to liquid water. In some embodiments the cover is formed from polyvinyl chloride and comprises a zip to open and close the cover to fully envelope the base, upper panel attached to the base and the inserts fitted to the base.

In some embodiments the cover is formed from a material having sufficient stiffness to structurally maintain the position of the inserts on the base of the mattress.

In some embodiments the cover has a substantially constant width and height so that the cover is looser over the air cell panel than in other regions of the mattress to allow for lowered surface tension in the cover and greater immersion in the air cells of the air cell panel.

In some embodiments a foot end of the cover is marked for correct orientation of the mattress.

In some embodiments the cover comprises an inner cover impermeable to water and a top cover fitted over the inner cover impermeable to liquid water and permeable to water vapour. In some embodiments the top cover is formed from a bi-elastic vapour permeable material. In some embodiments the top cover is fitted to a top edge of the inner cover and has sides that extend from the top edge of the mattress to or towards a bottom edge of the mattress. In some embodiments joints in the top cover are high-frequency welded joints.

In some embodiments adjacent inserts are fastened together by fasteners. In some embodiments the inserts are fastened to the base by fasteners. In some embodiments the fasteners are snap dome fasteners.

In some embodiments the high density foam forming the base of the mattress has a density of 30 to 50 kg/m3, or 30 to 45 kg/m3, or 30 to 40 kg/m3, or 35 to 40 kg/m3. In some embodiments the high density foam forming the upper panel has a density of 30 to 50 kg/m3, or 30 to 45 kg/m3, or 30 to 40 kg/m3, or 35 to 40 kg/m3.

In some embodiments the hardness of the high density foam forming the base is approximately twice the hardness of the high density foam forming the upper panel.

In some embodiments the base has a hardness of 150 to 250N, or 170 to 230N, or 190 to 210N, or about 200N.

In some embodiments the upper panel has a hardness of 75 to 125N, or 85 to 115N, or 95 to 105N, or about 100N.

In some embodiments the gel infused visco-elastic memory foam panel has a density of 55 to 75 kg/m3, or about 65 kg/m3.

In some embodiments the gel infused visco-elastic memory foam panel has a hardness of 40 to 55N, or 45 to 50N, or about 47N.

In some embodiments the foam panel base bonded to the gel infused visco-elastic memory foam panel has a density of 30 to 40 kg/m3, or about 35 kg/m3.

In some embodiments the foam panel base bonded to the gel infused visco-elastic memory foam panel has a hardness of 110 to 200, or 130 to 180, or 150 to 170N, or about 160N.

In some embodiments the visco-elastic memory foam panel has a density of 45 to 65 kg/m3, or about 55 kg/m3.

In some embodiments the visco-elastic memory foam panel has a hardness of 35 to 45N, or about 40N.

In some embodiments the foam panel base bonded to the visco-elastic memory foam panel has a density of 44 to 55 kg/m3, or about 50 kg/m3.

In some embodiments the foam panel base bonded to the visco-elastic memory foam panel has a hardness of 90 to 150N, or 100 to 140N, or 110 to 130N, or about 120N.

In some embodiments the high density foam of the base, the high density foam of the upper panel, the foam panel base bonded to the gel infused visco-elastic memory foam panel, and the foam panel base bonded to the visco-elastic memory foam panel are open cell polyurethane foam.

In some embodiments the high density foam of the base and the high density foam of the upper panel are combustible modified high resilience flexible polyurethane foam.

In this specification and claims, the terms hardness and firmness may be used interchangeably. Values for hardness and firmness expressed in Newtons (N) represent the Indentation Force Deflection (IFD) value for the foam to a 40% compression of the foam. IFD is a measure of the load bearing capacity of the foam and is generally measured as the force required to compress a 324 cm2 circular indentor foot into a part or block sample to a stated percentage of the samples initial height.

The term “comprising” as used in this specification and claims means “consisting at least in part of”, When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

Preferred embodiments of the invention will be described by way of example only and with reference to the drawings.

FIG. 1 is a perspective view of a mattress according to some embodiments of the present invention,

FIG. 2 is a perspective view of another mattress according to some embodiments of the present invention.

FIG. 3 is a perspective view of yet another mattress according to some embodiments of the present invention.

FIG. 4 is a close up perspective view illustrating an edge region of the mattress of FIG. 3.

FIG. 5 is a perspective view of a base and upper panel of the mattresses of FIGS. 1 to 3.

FIG. 6 is a perspective view of the mattress of FIG. 3 including a cover.

FIG. 7 is a perspective view of a cover or inner cover for the mattresses of FIGS. 1 to 3,

FIG. 8 is a perspective view of a cover comprising an inner cover and an outer cover for the mattresses of FIGS. 1 to 3.

FIG. 9 is a perspective view of the Mattress of FIG. 2 positioned on a bed with a head end of the mattress in an elevated seated position.

FIG. 10 is a perspective view of the Mattress of FIG. 3 positioned on a bed with a head end of the mattress in an elevated seated position.

### DETAILED DESCRIPTION OF PREFERRED EMBODIMENTS

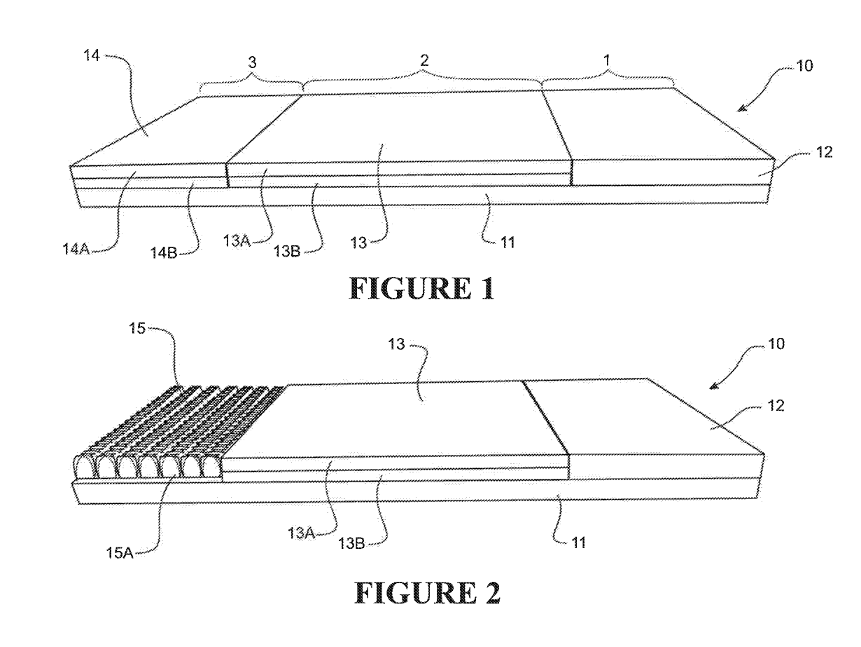

Preferred embodiments of the present invention are described with reference to FIGS. 1 to 10.

FIG. 1 illustrates a modular therapy mattress 10 (herein called a mattress) according to one embodiment of the present invention. The mattress comprises a base 11 of a high density foam material. An upper panel 12 is attached to the base in an upper body or head region 1 of the mattress. The upper panel 12 is also preferably formed from high density foam. In preferred embodiments the upper panel is bonded to the base 11 so that it is permanently affixed to the base. The base and upper panel are illustrated in FIG. 5.

In a mattress according to embodiments of the present invention the upper panel has a lower firmness than the base. The base has a higher firmness to support the softer upper panel and inserts fitted to the base described as below.

For example, in some embodiments the hardness of the high density foam forming the base is approximately twice the hardness of the high density foam forming the upper panel, In some embodiments the base has a hardness in the range of 150 to 250N, or 170 to 230N, or 190 to 210N, or about 200N. In some embodiments the upper panel has a hardness of 75 to 125N, or 85 to 115N, or 95 to 105N, or about 100N.

The high density foam of the upper panel and the base may have a density in the range of 30 to 50 kg/m3, or 30 to 45 kg/m3, or 30 to 40 kg/m3, or 35 to 40 kg/m3. In a preferred embodiment the density of the upper panel and the base are similar, for example in one particular embodiment the density of the base is about 38 kg/m3 and the density of the upper panel is about 36 kg/m3.

In a mattress according to embodiments of the present invention, one or more inserts 13, 14, 15 are fitted to the base in a trunk 2 and lower leg or heel region 3 of the mattress, as shown in FIGS. 1 to 3.

In some embodiments, as illustrated in FIGS. 1 and 2, an insert comprising visco-elastic memory foam panel 13A bonded to a foam panel base 13B is fitted to the base in a trunk region 2 of the mattress. Preferably the visco-elastic memory foam is a gel infused visco-elastic memory foam. The foam panel base boned to the gel infused visco-elastic memory foam has a higher firmness than the gel infused visco-elastic memory foam panel.

In some embodiments the hardness of the gel infused visco-elastic memory foam panel is approximately three times the hardness of the foam panel base. For example, in some embodiments the gel infused visco-elastic memory foam panel has a hardness in the range of 40 to 55N, or 45 to 50N, or about 47N, and the foam panel base bonded to the gel infused visco-elastic memory foam panel has a hardness of 110 to 200, or 130 to 180, or 150 to 170N, or about 160N.

In some embodiments the gel infused visco-elastic memory foam panel has a density of 55 to 75 kg/m3, or about 65 kg/m3. In some embodiments the foam panel base bonded to the gel infused visco-elastic memory foam panel has a density of 30 to 40 kg/m3, or about 35 kg/m3. In some embodiments the density of the gel infused visco-elastic memory foam panel is about twice the density of the foam panel base bonded to the gel infused visco-elastic memory foam panel.

The use of the gel infused visco-elastic memory foam panel in the trunk region of the mattress can reduce trapped body heat, speed up spring back time and help the mattress feel softer in the trunk region compared to other mattress materials.

In the embodiment of FIG. 1, an insert comprising a visco-elastic memory foam panel 14A bonded to a foam panel base 14B is fitted to the base in a lower leg or heel region 3 of the mattress. The foam panel base boned to the visco-elastic memory foam has a higher firmness than the visco-elastic memory foam panel. The visco-elastic memory foam panel used in the lower leg or heel region preferably is not gel infused memory foam.

In some embodiments the hardness of the visco-elastic memory foam panel is approximately three times the hardness of the foam panel base. For example, in some embodiments the visco-elastic memory foam panel has a hardness of 35 to 45N, or about 40N. In some embodiments the foam panel base bonded to the visco-elastic memory foam panel has a hardness of 90 to 150N, or 100 to 140N, or 110 to 130N, or about 120N.

In some embodiments the visco-elastic memory foam panel has a density of 45 to 65 kg/m3, or about 55 kg/m3. In some embodiments the foam panel base boned to the visco-elastic memory foam panel has a density of 44 to 55 kg/m3, or about 50 kg/m3. In some embodiments the density of the visco-elastic memory foam panel is about the same as the density of the foam panel base bonded to the visco-elastic memory foam panel.

In a preferred embodiment the density of the visco-elastic memory foam used in the truck region of the mattress is greater than the density of the visco-elastic memory foam used in the lower leg or heel region of the mattress.

In some embodiments the high density foam of the base, the high density foam of the upper panel, the foam panel base bonded to the gel infused visco-elastic memory foam panel, and the foam panel base bonded to the visco-elastic memory foam panel are open cell polyurethane foam. Preferably the high density foam of the base and the high density foam of the upper panel are combustible modified high resilience flexible polyurethane foam.

The use of the visco-elastic memory foam panel in the lower leg or heel region of the mattress can accommodate the bony structures of a patient's heels and ankles with very low surface tension, reducing shear forces on the patient in these areas.

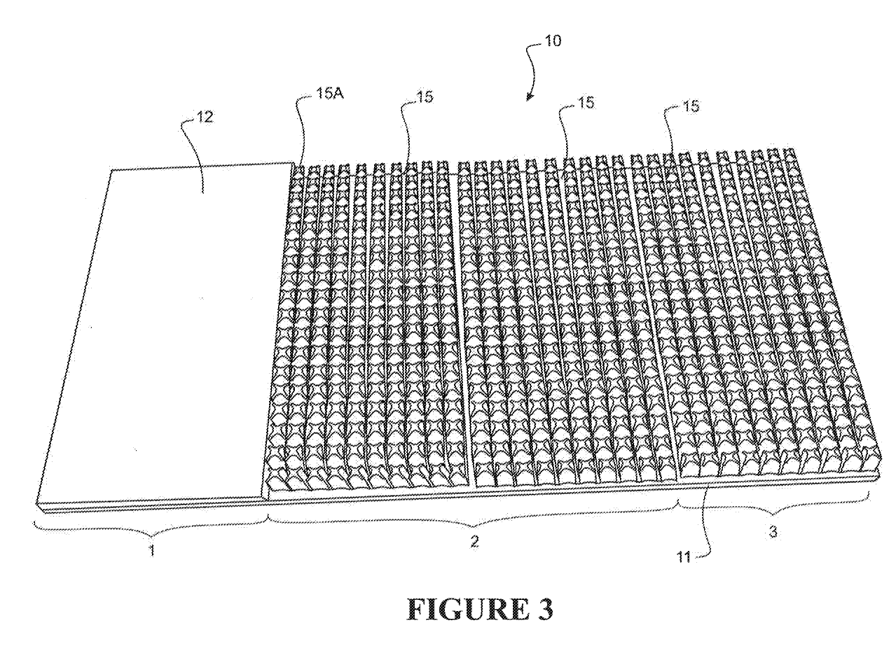

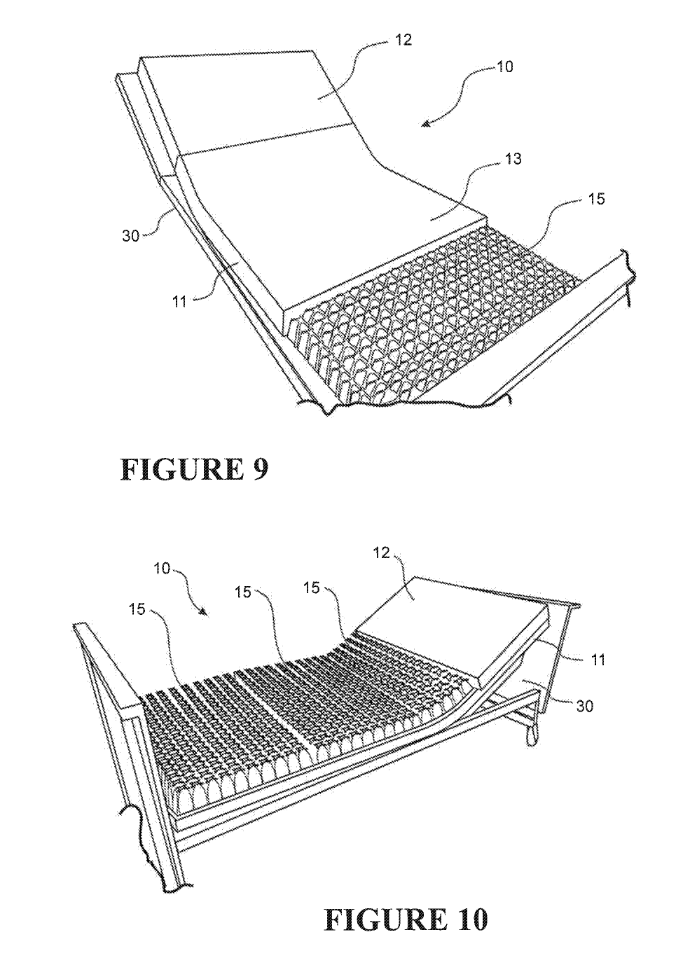

In some embodiments, the mattress comprises an insert comprising an air cell panel 15, as illustrated in FIGS. 2 and 3. The mattresses of FIGS. 2 and 3 are also shown in FIGS. 9 and 10 positioned on a bed with a head end of the mattress elevated to a seated position. The air cell panel comprises a plurality of air cells. The air cell panel is formed from a generally flat base sheet and a top sheet both made from an air impervious material. The top sheet is molded to form the plurality of air cells and is fixed to the base sheet around bottom edges of the air cells. Preferably the air cell panel has a valve for inflating the air cells with air, the air cells all in fluid communication with the valve. An example air cell panel is Roho® air cell cushions by the Roho Group.

In some embodiments the air cell panel 15 is fitted to the mattress in the lower leg or heel region 3 of the mattress, as illustrated in FIG. 2. In some embodiments, the mattress comprises one or more air cell panels 15 fitted to the trunk region and the lower leg or heel region of the mattress, as shown in FIG. 3.

The length of the trunk region 2 of the mattress is preferably greater than the length of the upper body and head region 1 of the mattress, and is preferably greater in length than the lower leg and heel region 3 of the mattress. For example, in some embodiments the upper body and head region is approximately 25% of the length of the mattress, the lower leg or heel region is approximately 25% of the length of the mattress, and the trunk region located in between the upper body and head region and the lower leg or heel region is approximately 50% of the length of the mattress. Thus in some embodiments the insert fitted to the base in the trunk region is approximately twice the length of the insert fitted to the base in the lower leg or heel region. In some embodiments therefore, the mattress comprises three inserts of approximately the same length, two inserts of the same construction fitted to the base in the trunk region and one insert fitted to the base in the lower leg or heel region. Three inserts of the same construction may be fitted to the base in the trunk region and in the lower leg or heel region of the mattress. For example, the illustrated embodiment of FIG. 3 comprises 3 inserts, two inserts in the trunk region and one insert in the lower leg or heel region, and each of the three inserts is an air cell panel 15 as described above. In some embodiments a single insert spanning both the trunk and lower leg or heel region may be fitted to the mattress, for example the single insert may comprise an air cell panel.

In a mattress according to the present invention, with the insert or inserts fitted to the base the overall thickness of the mattress 10 in the upper body and head region 1, the trunk region 2 and the lower leg or heel region 3 is substantially the same. For the air cell panel 15 the overall thickness is the height of the air cell panel to the top of individual air cells 15A. Thus with the inserts fitted to the base of the mattress the mattress has a substantially constant height along the length of the mattress. In embodiments comprising an air cell panel, the height of the mattress along the length of the mattress is constant relative to the height of the air cells of the air cell panel.

In some embodiments the thickness of the base is less than the thickness of the inserts. In a preferred embodiment the thickness of the inserts is approximately 1 to 2 times the thickness of the base. In a most preferred embodiment the thickness of the inserts is approximately 1.5 times the thickness of the base. For example the base thickness is about 50 mm or 2 inches and the insert thickness is about 75 mm or 3 inches such that the overall thickness of the mattress is about 125 mm or 5 inches.

In some embodiments the thickness of the gel infused visco-elastic memory foam panel 13A is similar to the thickness of the foam panel base 13B to which it is bonded. For example the thickness of the gel infused visco-elastic memory foam panel and the foam panel base to which it is bonded is about 38 mm. Similarly, in some embodiments the thickness of the visco-elastic memory foam panel 14A is similar to the thickness of the foam panel base 14B to which it is bonded, again by example 38 mm.

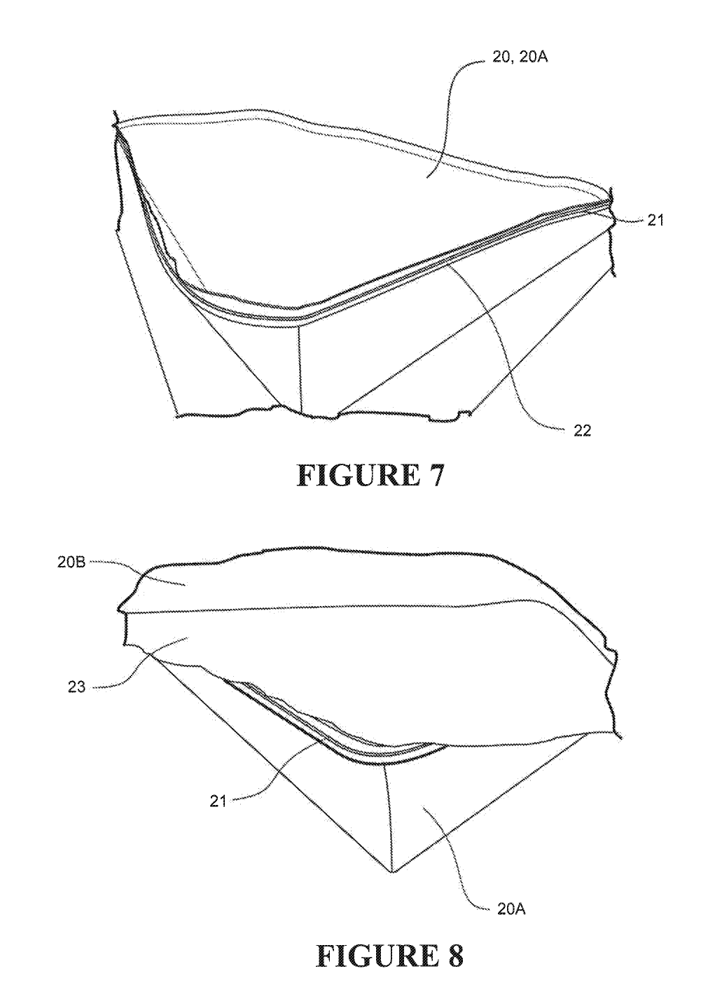

A mattress according to the present invention comprises a cover 20 that fully envelopes the base 11, the upper panel 12 and the insert or inserts 13, 14, 15 fitted to the base. In some embodiments, the cover is formed from a material having sufficient stiffness to structurally maintain the position of the inserts on the base of the mattress. That is, the cover holds the inserts in position on the base. For example, in some embodiments the cover is formed from a material that has sufficient strength such that the cover does not stretch or deform. As the cover is sized to fit the base, upper panel and inserts closely the inserts are held correctly in position on the base. In some embodiments the cover 20 is formed from polyvinyl chloride (PVC) and comprises a zip 21 to open and close the cover to fully envelope and closely fit to the base, upper panel attached to the base and the inserts fitted to the base, as shown in FIG. 7. In some embodiments the cover is reinforced to ensure the cover is structurally sound to retain the inserts in the correct position on the base. For example, in some embodiments the cover is reinforced with a polyester scrim bonded to an inner surface of a polymer material. For example, in one preferred embodiment the cover is formed from a PVC sheet material with a polyester scrim bonded to an inner surface of the PVC sheet material.

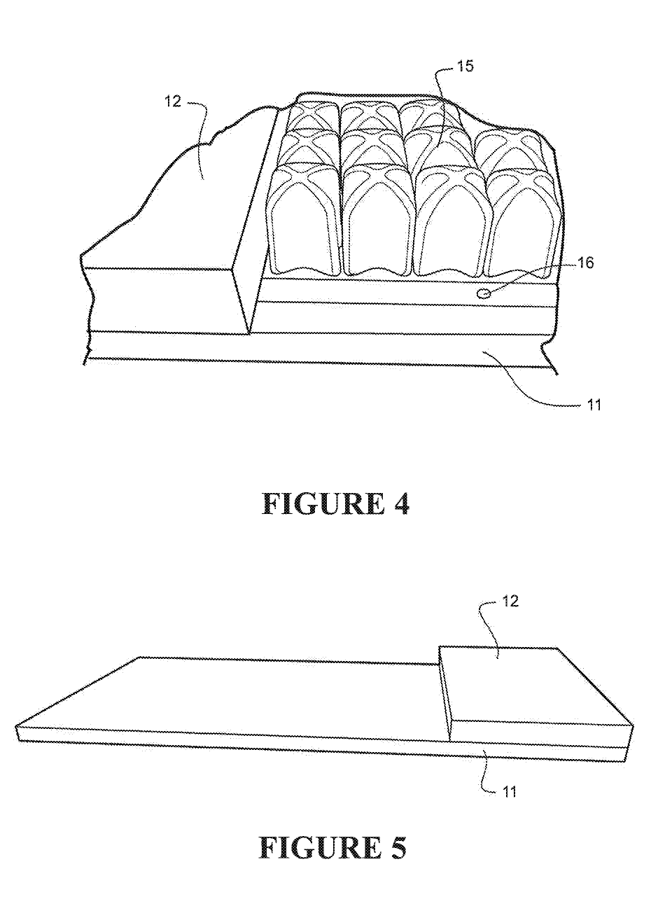

Additionally or alternatively in some embodiments the inserts may be fastened to the base by fasteners (16 in FIG. 4). In some embodiments adjacent inserts are fastened together by fasteners. In some embodiments the fasteners are snap dome fasteners.

Preferably the cover is impervious to liquids to be suitable for incontinent patients. In some embodiments the cover comprises an inner cover 20A impermeable to water and an outer cover 20B fitted over the inner cover that is impermeable to liquid water and permeable to water vapour. For example the inner cover 20A is formed from polyvinyl chloride, and the outer cover 20B is formed from a bi-elastic vapour permeable material. The outer cover aids to reduce friction between the mattress and the patient's body. Preferably joints in the outer cover are high-frequency welded joints to prevent water penetrating the joints. In some embodiments the outer cover is fitted to a top edge 22 of the inner cover 20A and has sides 23 that extend from the top edge of the mattress to or towards a bottom edge of the mattress. For example the outer cover is zipped to a top edge of the inner cover. A portion of sides 23 of the outer cover 20B are shown in FIG. 8 lifted away from the sides of the mattress to show the inner cover below.

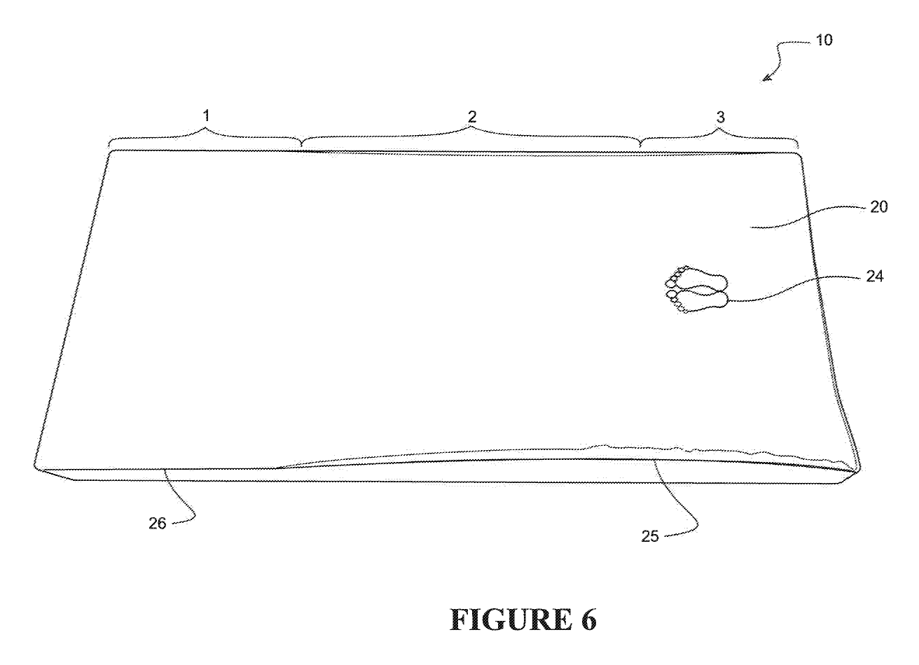

As the location of the insert or inserts on the base may not be apparent when the cover is covering the base, upper panel and insert, preferably a foot end of the cover is marked for correct orientation of the mattress on a bed, to ensure a patient's head is placed at the correct and of the mattress. For example, as shown in FIG. 6 a foot icon may be applied to the mattress cover to indicate the foot end of the mattress.

In preferred embodiments the width of the air cell panel 15 is less than the width of the base 11 and the upper panel 12. In use the air cell panel is mounted centrally between longitudinal edges of the base so that an edge of the air cell panel is spaced from an edge of the base, as shown in FIG. 4. In some embodiments the width of the air cell mattress is 20 mm to 200 mm, or 20 mm to 150 mm, or 20 mm to 100 mm, or 50 mm to 100 mm or about 80 mm less than the width of the base (for example so that the edge of the air cell panel is spaced about 40 mm from an edge of the base).

Preferably the width of the upper panel, the gel infused visco-elastic memory foam panel, and the visco-elastic memory foam panel is approximately the same as the width of the base. With the width of the air cell panel being narrower than the base, upper panel and other inserts if fitted to the base, preferably the cover has a substantially constant width and height so that the cover is looser over the air cell panel than in other regions of the mattress. For example, as shown in FIG. 6, the cover is looser over the trunk and lower leg or heel region of the mattress than in the head or upper body region of the mattress, with an upper edge 25 of the mattress cover in the trunk and lower leg or heel region folding inwards compared to an upper edge 26 of the cover in the upper body or head region of the mattress. Having the cover looser over the air cell panel allows reduces surface tension in the cover allowing the outer cover to collapse to provide more immersion of a person's body (for example legs or heels) into the air cell panel to provide increased comfort.

Tile various modular therapy mattresses comprising the particular inserts and arrangement of inserts described provide therapy mattress options to reduce the risk of pressure ulcers on a bed-bound patient and increase comfort by pressure redistribution. The modular therapy mattresses of the present invention are designed to reduce tissue/cellular deformation particularly in the elevated patient as well as the supine/prone and side lying positions. The novel modular therapy mattresses according to the present invention comprises a receptive foam base and cover than can receive a variety of inserts to make a complete therapy mattress to suit a particular patient's requirements. Although the therapy mattress comprises inserts fitted to a base, the design of the therapy mattress provides for a stable mattress and allows for stable transfer of the patient into and out of the bed, for example transfer from the bed to a standing position, transfer from the bed to a chair or transfer from the bed to a trolley.

The foregoing description of the invention includes preferred forms thereof. Modifications may be made thereto without departing from the scope of the invention as defined by the accompanying claims.

1. A modular therapy mattress comprising:
a base of high density foam,
n upper panel of high density foam attached to the base in an upper body and head region of the mattress, the upper panel having a lower firmness than the base,
one or more inserts fitted to the base in a trunk, lower leg or heel region of the mattress, wherein the inserts comprise one or more of:
(iv) a gel infused visco-elastic memory foam panel bonded to a foam panel base, the foam panel base having a higher firmness than the gel infused visco-elastic memory foam panel,
(v) a visco-elastic memory foam panel bonded to a foam panel base, the foam panel base having a higher firmness than the visco-elastic memory foam panel,
(vi) an air cell panel comprising a plurality of air cells formed from a generally flat base sheet and a top sheet both made from an air impervious material, the top sheet molded to form the plurality of air cells fixed to the base sheet around bottom edges of the air cells, and
a cover fully enveloping the base, the upper panel and the insert or inserts fitted to the base.

2. A modular therapy mattress as claimed in claim 1, wherein the width of the air cell panel is less than the width of the base and the upper panel, in use the air cell panel mounted centrally between longitudinal edges of the base.

3. A modular therapy mattress as claimed in claim 2, wherein the width of the air cell mattress is 20 mm to 200 mm, or 20 mm to 150 mm, or 20 mm to 100 mm, or 50 mm to 100 mm or about 80 mm less than the width of the base.

4. A modular therapy mattress as claimed in claim 2, wherein the width of the upper panel, the gel infused visco-elastic memory foam panel, and the visco-elastic memory foam panel is approximately the same as the width of the base.

5. A modular therapy mattress as claimed in claim 1, wherein the thickness of the base is less than the thickness of the inserts.

6. A modular therapy mattress as claimed in claim 5, wherein the thickness of the inserts is approximately 1 to 2 times the thickness of the base, or approximately 1.5 times the thickness of the base.

7. A modular therapy mattress as claimed in claim 1, wherein the thickness of the gel infused visco-elastic memory foam panel is similar to the thickness of the foam panel base to which it is bonded, and/or the thickness of the visco-elastic memory foam panel is similar to the thickness of the foam panel base to which it is bonded.

8. A modular therapy mattress as claimed in claim 1, wherein in use the gel infused visco-elastic memory foam panel is fitted to the base in the trunk region of the mattress.

9. A modular therapy mattress as claimed in claim 1, wherein in use the visco-elastic memory foam panel is fitted to the base in the lower leg or heel region of the mattress.

10. A modular therapy mattress as claimed in claim 1, wherein in use a said visco-elastic memory foam panel is fitted to the base in the lower leg or heel region of the mattress, and a said visco-elastic memory foam panel is fitted to the base in the trunk region of the mattress, and wherein the density of the visco-elastic memory foam in the truck region of the mattress is greater than the density of the visco-elastic memory foam in the lower leg or heel region of the mattress.

11. A modular therapy mattress as claimed in claim 1, wherein in use the air cell panel is fitted to the lower leg or heel region.

12. A modular therapy mattress as claimed in claim 1, comprising one or more said air cell panels, in use the air cell panels fitted to the trunk region and the lower leg or heel region.

13. A modular therapy mattress as claimed in claim 1, wherein the base thickness is about 50 mm or 2 inches and the insert thickness is about 75 mm or 3 inches, the overall thickness of the mattress being about 125 mm or 5 inches.

14. A modular therapy mattress as claimed in claim 1, wherein the upper body and head region is approximately 25% of the length of the mattress, the lower leg or heel region is approximately 25% of the length of the mattress, and the trunk region located in between the upper body and head region and the lower leg or heel region is approximately 50% of the length of the mattress.

15. A modular therapy mattress as claimed in claim 1, comprising three said inserts, the inserts having approximately the same length, two inserts of the same construction fitted to the base in the trunk region and one insert fitted to the base in the lower leg or heel region.

16. A modular therapy mattress as claimed in claim 1, comprising three said inserts fitted to the base in the lower leg or heel region and the trunk region, each insert comprising an air-cell panel.

17. A modular therapy mattress as claimed in claim 1, wherein with the insert or inserts fitted to the base the overall thickness of the mattress in the upper body and head region, the trunk region and the lower leg or heel region is substantially the same.

18. A modular therapy mattress as claimed in claim 1, wherein the cover is formed from a material having sufficient stiffness to structurally maintain the position of the inserts on the base of the mattress.

19. A modular therapy mattress as claimed in claim 4, wherein the cover has a substantially constant width and height so that the cover is looser over the air cell panel than in other regions of the mattress to allow for lowered surface tension in the cover and greater immersion in the air cells of the air cell panel.

20. A modular therapy mattress as claimed in claim 1, wherein the hardness of the high density foam forming the base is approximately twice the hardness of the high density foam forming the upper panel.
